(19) United States
(12) Patent Application Publication
(10) Pub. No.: US 2017/0090710 A1
(43) Pub. Date: Mar. 30, 2017

(54) DISPLAY CONTROL DEVICE AND DISPLAY CONTROL METHOD

(71) Applicant: FUJITSU LIMITED, Kawasaki-shi (JP)

(72) Inventors: Hiroyuki Maekawa, Kawasaki (JP); Takehiko Raku, Zama (JP); Akari Maejima, Kawasaki (JP); Koji Saito, Kawasaki (JP)

(21) Appl. No.: 15/278,506

(22) Filed: Sep. 28, 2016

(30) Foreign Application Priority Data
Sep. 30, 2015 (JP) 2015-194760

(51) Int. Cl. G06F 3/0486; G06F 3/0481

(52) U.S. Cl. CPC G06F 3/0486; G06F 3/04817; G06F 3/04812; G06F 2203/04803

(57) ABSTRACT

A display control method includes receiving a drag operation performed on a window displayed on a display screen; displaying a plurality of arrangement icons on the display screen at preset areas on the display screen, the arrangement icons corresponding to at least one of a plurality of divided display areas, the divided display areas being at least one set of non-overlapping portions of the display screen, the at least one set of non-overlapping portions of the display screen covering the entire display screen; and when a drop position of the drag operation is within one of the preset areas on the display screen, displaying the window at a size and location corresponding to the at least one of the plurality of divided display areas represented by an arrangement icon displayed at the one of the preset areas.

### CROSS-REFERENCE TO RELATED APPLICATION

This application is based upon and claims the benefit of priority of the prior Japanese Patent Application No. 2015-194760, filed on Sep. 30, 2015, the entire contents of which are incorporated herein by reference.

### FIELD

The embodiment discussed herein is related to a display control device and a display control method.

### BACKGROUND

In a known drag-and-drop technique, when a user performs a drag-and-drop operation on a window on a display screen, the window is moved to and dropped at a position according to the user operation, and is displayed at the drop position (see, for example, Japanese Laid-open Patent Publication Nos. 2001-325054 and 2006-185025). After moving the window, the user manually makes fine adjustments on the window, such as placing the window at a desired position or resizing the window into a desired size.

Meanwhile, there is a method which allows a user not to manually make such fine adjustments, by limiting the moving range and size of a window (see, for example, Japanese Laid-open Patent Publication No. 2012-27891). In one method for example, when a certain window is moved over a different window in a multi-window environment, the certain window is reduced in size and displayed at a predetermined position on the overlapping different window.

### SUMMARY

According to an aspect of the invention, a display control method includes receiving a drag operation performed on a window displayed on a display screen; displaying a plurality of arrangement icons on the display screen at preset areas on the display screen, the arrangement icons corresponding to at least one of a plurality of divided display areas, the divided display areas being at least one set of non-overlapping portions of the display screen, the at least one set of non-overlapping portions of the display screen covering the entire display screen; and when a drop position of the drag operation is within one of the preset areas on the display screen, displaying the window at a size and location corresponding to the at least one of the plurality of divided display areas represented by an arrangement icon displayed at the one of the preset areas.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed

### BRIEF DESCRIPTION OF DRAWINGS

FIG. 1 is a diagram illustrating an example of the hardware configuration of a display control device according to an embodiment.

FIG. 2 is a diagram illustrating an example of the function and configuration of the display control device according to the embodiment.

FIG. 3 is a diagram illustrating an example of a fitting coordinate table according to the embodiment.

FIG. 4 is a flowchart illustrating an example of display control processing according to the embodiment.

FIG. 5 is a flowchart illustrating an example of fitting processing according to the embodiment.

FIGS. 6A to 6C are diagrams illustrating an example of a display screen according to the embodiment.

FIGS. 7A to 7C are diagrams illustrating an example of a display screen according to the embodiment.

FIG. 8 is a diagram illustrating an example of display screen registration according to the embodiment.

FIG. 9 is a diagram illustrating an example of an alternative configuration of the display control device according to the embodiment.

### DESCRIPTION OF EMBODIMENT

The above techniques, however, may not display the moved window at a position desired by the user; consequently, the window may not be placed at the position intended by the user.

Thus, in one aspect, the embodiment discussed herein aims to place a window on a particular divided area on a display screen more easily than placing the window by moving the window directly over that particular area.

An embodiment is described below with reference to the accompanying drawings. Note that components, herein and in the drawings, having substantially the same function are denoted by the same reference numeral and described only once.

[Hardware Configuration of the Display Control Device]

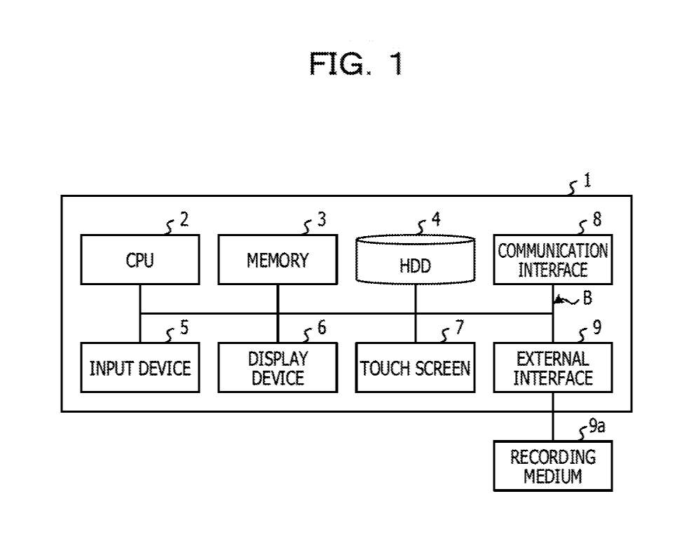

First, an example of the hardware configuration of a display control device 1 according to the present embodiment is described with reference to FIG. 1. The display control device 1 according to the present embodiment is implemented by a personal computer (PC). The display control device 1 is however not limited to this, and may be implemented by a tablet PC, a smartphone, a personal digital assistant (PDA), a mobile phone, a portable music reproduction device, a portable video processing device, a portable video game console, or the like.

The display control device 1 has a central processing unit (CPU) 2, a memory 3, a hard disk drive (HOD) 4, an input device 5, a display device 6, a touch screen 7, a communications interface 8, and an external interface 9. All these parts are connected by buses B.

The memory 3 may be random access memory (RAM) or read-only memory (ROM). RAM is a volatile semiconductor memory capable of retaining programs and data temporarily. ROM is a non-volatile semiconductor memory capable of retaining data even after having been turned off. The RAM or ROM stores programs and data for network settings and the like.

The HDD 4 is a non-volatile recording device and may store programs and data. The programs and data stored in the HDD 4 include control programs for overall control of the display control device 1 and application programs. The control programs include a display control program executed by the CPU 2 or a hardware processor in the present embodiment.

The CPU 2 or the hardware processor performs overall control of the display control device 1 or implements a display control function installed in the display control device 1, by reading the control programs and data from the HDD 4, saving the control programs and data in the memory 3, and executing predetermined processing based on the control programs and data.

The input device 5 includes, for example, a keyboard or a mouse, and inputs a drag-and-drop operation according to user operation. The display device 6 includes a display and is capable of displaying multiple windows on a display screen at once. The touch screen 7 is layered on the display screen of the display device 6 and detects a touch operation by the user. The touch screen 7 detects when an operation object, such as a finger of the user, touches the touch screen 7. Thus, the display device 6 functions also as an input device. The display device 6 may be without the touch screen 7.

The communications interface 8 is an interface used to connect the display control device 1 to a network. The communications interface 8 allows the display control device 1 to perform data communications with another device.

The external interface 9 is an interface used to connect the display control device 1 to an external device. The external device is, for example, a recording medium 9a. The external interface 9 allows the display control device 1 to read data from the recording medium 9a and/or write data to the recording medium 9a. Examples of the recording medium 9a include a compact disk (CD), a digital versatile disk (DVD), a Secure Digital (SD) memory card, and a Universal Serial Bus (USB) memory.

[Function and Configuration of the Display Control Device]

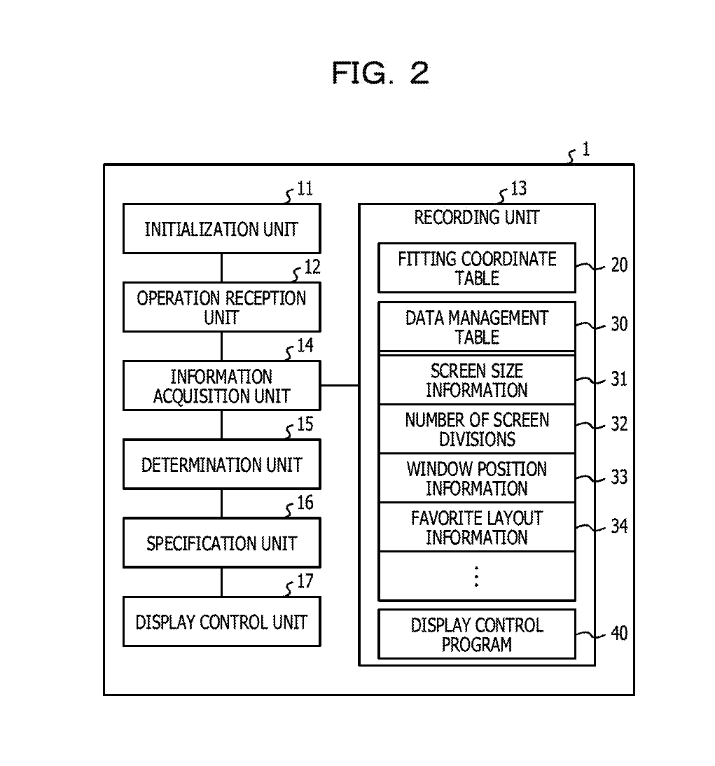

Next, an example of the function and configuration of the display control device 1 according to the present embodiment is described with reference to FIG. 2. The display control device 1 has an initialization unit 11, an operation reception unit 12, a recording unit 13, an information acquisition unit 14, a determination unit 15, a specification unit 16, and a display control unit 17.

The initialization unit 11 initializes a fitting coordinate table 20. The operation reception unit 12 receives a user operation performed on a window displayed on the display screen. The operation reception unit 12 receives a drag operation on a window and then starts monitoring the position (coordinates) of the window which changes as the window moves. The operation reception unit 12 also receives a drop operation on the monitored window, separately from the drag operation. The operation reception unit 12 detects the coordinates of the window at the time of being dropped, and if the detected coordinates are particular coordinates (e.g., on an arrangement icon to be described later), moves the window to a predetermined display area corresponding to that arrangement icon. Known methods are used to detect the drag-and-drop operations on the window and to control the position and size of the window. Thus, detailed descriptions for such methods are omitted herein.

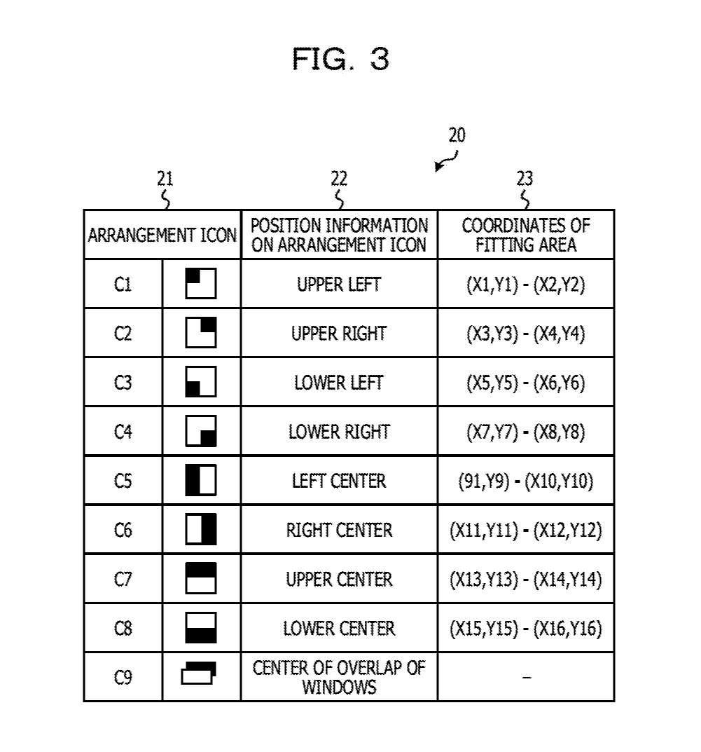

The recording unit 13 records the fitting coordinate table 20, a data management table 30, a display control program 40, and other control programs and various pieces of data. Recorded in the fitting coordinate table 20 beforehand are the correspondences between locations on the display screen and display areas obtained by dividing the display screen. FIG. 3 illustrates an example of the fitting coordinate table 20 according to the embodiment.

The fitting coordinate table 20 includes the following data items: arrangement icon 21, position information on arrangement icon 22, and coordinates of fitting area 23. The arrangement icon 21 indicates the name of an arrangement icon and the appearance (mark) of the arrangement icon displayed on the display screen. The position information on arrangement icon 22 indicates the position on the display screen to display the corresponding icon.

The coordinates of fitting area 23 indicates the coordinates specifying a display area for the corresponding arrangement icon 21, the display area being obtained by dividing the display screen. The window display areas specified by the coordinates of fitting area 23 are set so as not to overlap with one another.

For example, with the display screen being quartered into upper left, upper right, lower left, and lower right display areas, the coordinates of fitting area 23 specify the upper left quarter display area for the arrangement icon 21 “C1”, and specify the upper right quarter display area for the arrangement icon 21 “C2”. The coordinates of fitting area 23 specify the lower left quarter display area for the arrangement icon 21 “C3”, and specify the lower right quarter display area for the arrangement icon 21 “C4”. For the arrangement icons 21 “C5 to C8”, the coordinates of fitting area 23 specify either the left, right, upper, or lower half area of the display screen which is halved into left and right display areas or upper and lower display areas.

The marks of the arrangement icons 21 and the position information on arrangement icon 22 do not have to be recorded in the fitting coordinate table 20.

Referring back to FIG. 2, the data management table 30 has screen size information 31 on the display device 6, number of screen divisions 32, window position information 33, and favorite layout information 34. The information acquisition unit 14 acquires, for example the screen size information 31 on the display device 6, the number of screen divisions 32, the window position information 33, and the favorite layout information 34. The window position information 33 indicates the coordinates of the dragged window before the drag.

The determination unit 15 determines whether an operation received by the operation reception unit 12 is a drag to any of the preset locations on the display screen. When the operation received by the operation reception unit 12 is a drag to any of the preset locations on the display screen, the specification unit 16 refers to the fitting coordinate table 20 and specifies a fitting area (window display area) corresponding to the location specified by the drag operation.

The display control unit 17 displays the moved window on the display device 6 according to the specified display area. When there is a different window at the position where a certain window is dropped, the display control unit 17 displays these windows on the display device 6 after switching their positions. Specifically, the display control unit 17 displays the certain window at the dropped position and displays the other window at the position from which the certain window has been moved.

With this configuration, the CPU 2 of the display control device 1 according to the present embodiment executes display control processing, to be described later, using the display control program 40 stored in the memory 3 or the like. The display control program 40 according to the present embodiment may be a resident program which is resident in the memory 3 while the OS of the display control device 1 is running. When the user performs a drag-and-drop operation while the display control device 1 is executing a certain application, an interrupt occurs. In response to the interrupt by the drag-and-drop operation, the CPU 2 executes the display control processing in accordance with the procedures indicated by the display control program 40.

The information recorded in the fitting coordinate table 20 illustrated in FIG. 3 and in the data management table 30 may be recorded in the memory 3 or the HDD 4, or may alternatively be stored in, for example, a cloud server connected to the display control device 1 via a network.

[Display Control Processing]

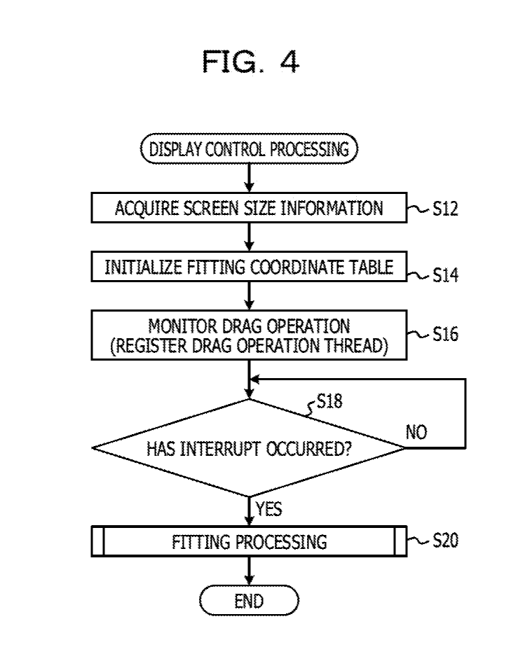

Next, an example of the display control processing according to the present embodiment is described with reference to FIG. 4. Once the display control processing is started, the information acquisition unit 14 acquires screen size information (Step S12). The recording unit 13 records the acquired screen size information in the screen size information 31 of the data management table 30.

Next, the initialization unit 11 initializes the fitting coordinate table 20 (Step S14). The initialization unit 11 divides the display screen based on the acquired screen size information and sets, for each arrangement icon 21, the coordinates of fitting area 23 defining one of the divided display areas.

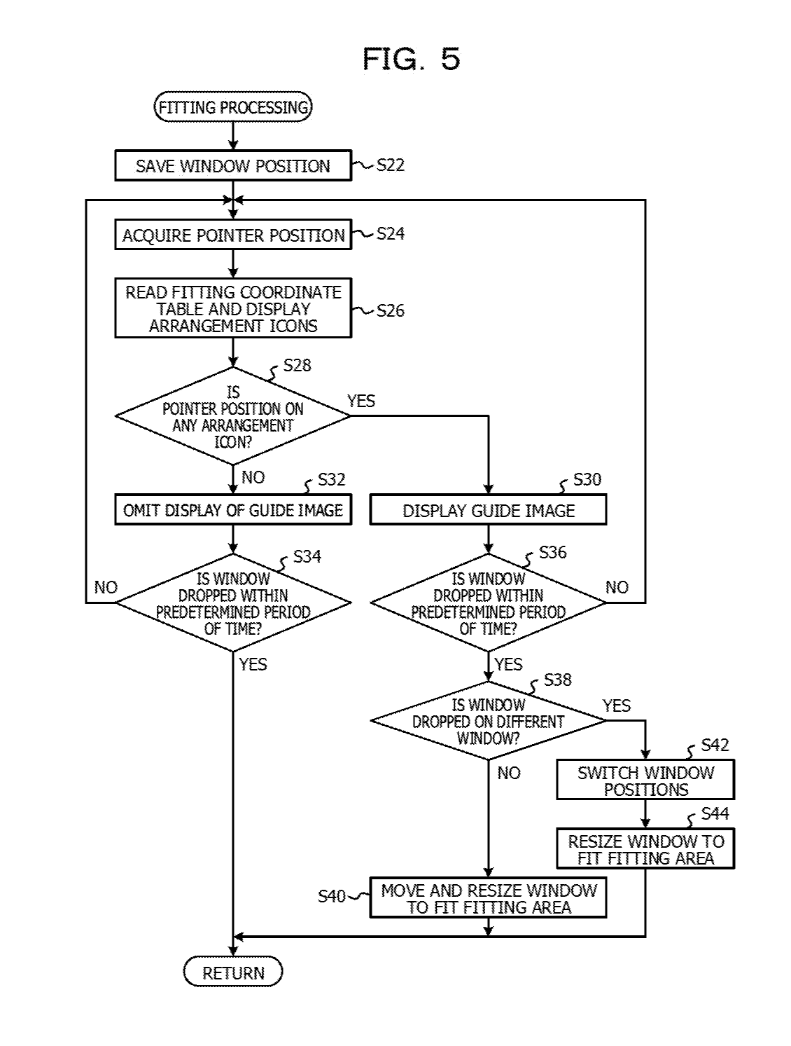

Next, the operation reception unit 12 registers a drag operation thread, and starts monitoring a drag operation by the user (Step S16). The determination unit 15 determines whether an interrupt by a drag operation has occurred (Step S18). When the user performs a drag operation, an interrupt occurs for the drag operation thread for executing fitting processing according to the drag operation event. When the determination unit 15 determines that an interrupt has occurred, the fitting processing is performed (Step S20, FIG. 5), and this display control processing ends.

[Fitting Processing]

Once the fitting processing in FIG. 5 is started, the information acquisition unit 14 acquires the coordinates of the pre-drag display position of the window on which the drag operation is being performed (Step S22). The recording unit 13 records the acquired coordinates of the display position of the window in the window position information 33 of the data management table 30.

Next, the information acquisition unit 14 acquires the position of a pointer moved by the drag operation (Step S24). In the present embodiment, the position of the pointer is the position of a cursor. However, the embodiment is not limited to this. The position of the pointer may be a position on the touch screen 7 touched or approached by a finger of the user.

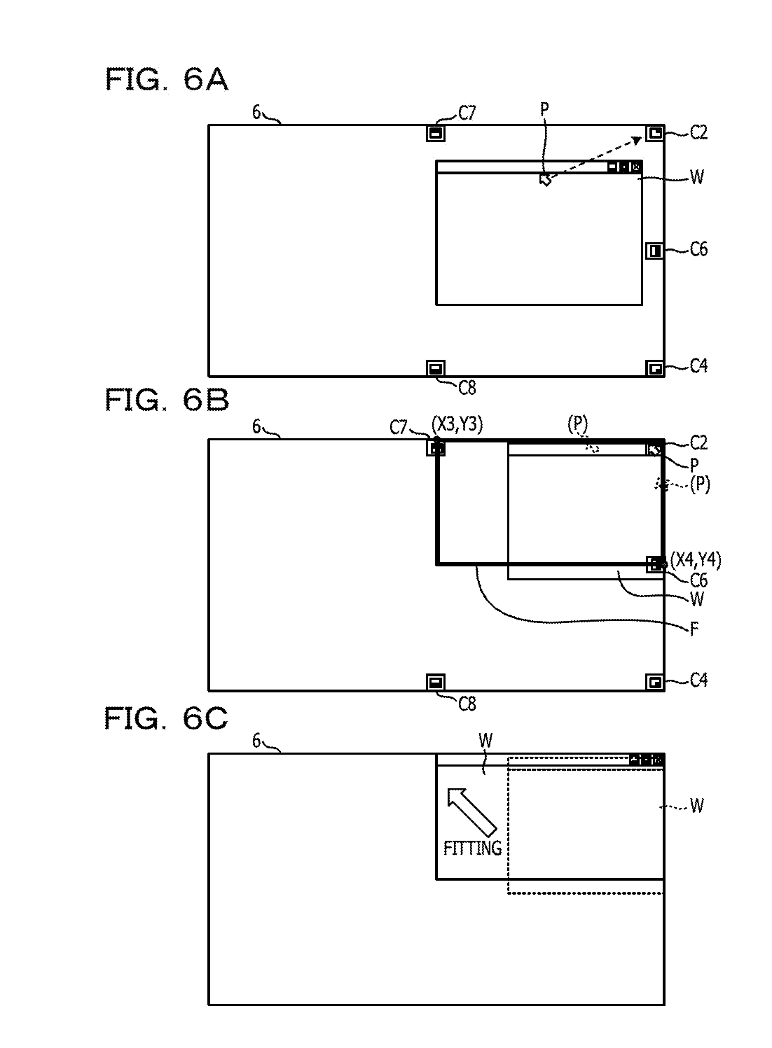

Next, the display control unit 17 reads information from the fitting coordinate table 20 and displays arrangement icons based on the position of the pointer (Step S26). For example, in FIG. 6A, a window W displayed on the display screen is being dragged and is therefore active. In this state, the user moves a pointer P to the upper right of the screen. During this pointer moving operation, the arrangement icons C2, C4, C6, C7, and C8 are being displayed in the example in FIG. 6A, the arrangement icons being determined according to the moving direction of the window W to correspond to the directions in which the pointer P is likely to move.

The embodiment is not limited to this method of displaying arrangement icons, however. For example, without taking the moving direction of the pointer P into consideration, all the arrangement icons C1 to C9 may be displayed at their predetermined positions on the screen, according to the position information on arrangement icon 22 in the fitting coordinate table 20 illustrated in FIG. 3. The predetermined positions on the screen may be the four corners of the screen, the center of each side of the screen, the center of each area obtained by dividing the screen, and the like. For example, the display control unit 17 may display some or all of the arrangement icons C1 to C9, or in other words, do not have to display all of the arrangement icons C1 to C9.

The display color or outline of each of the arrangement icons C1 to C9 may darken as the pointer P approaches the arrangement icon and pales as the pointer P moves away from the arrangement icon, or vice versa. The arrangement icons C1 to C9 may disappear once the pointer P is moved over any of the arrangement icons C1 to C9. The arrangement icons C1 to C9 may reappear once the pointer P is moved away from any of the arrangement icons C1 to C9.

The coordinates of fitting area 23 in the fitting coordinate table 20 do not have to correspond one-to-one to the arrangement icons 21 for C1 to C8. In the present embodiment, for example, when the pointer P is moved over the arrangement icon C2 displayed on the upper right corner of the screen in FIG. 6B, an area defined by (X3, Y3)-(X4, Y4) of the coordinates of fitting area 23 corresponding to the arrangement icon 21 for C2 is specified as a display area for the window W. The same area as the area displayed when the pointer P is moved over the arrangement icon C2 may be specified when the pointer P (outlined by dots) is placed on the right part on the upper side of the screen or on the upper part on the right side of the screen in FIG. 6B.

Referring back to FIG. 5, next, the determination unit 15 determines whether the pointer P is located on any arrangement icon (Step S28). When it is determined that the pointer P is located on any arrangement icon, the specification unit 16 specifies, based on the coordinates of fitting area 23 in the fitting coordinate table 20, a fitting area corresponding to the arrangement icon on which the pointer is located. The display control unit 17 displays a guide image F indicating the specified fitting region (Step S30). When the pointer P is moved in the upper right direction to move the window W accordingly as illustrated in FIG. 6A and then placed over the arrangement icon C2 as illustrated in FIG. 6B, the guide image F is displayed on the specified fitting area.

The guide image F according to the present embodiment illustrates how the window looks like when fitted in one of the display areas (fitting areas) obtained by dividing the screen. This allows the user to preview how the window W, being dragged by the user, will look like when displayed at the display position of the guide image F after being resized to fit the fitting area. The guide image F may disappear when the pointer P moves away from the arrangement icon, or does not have to be displayed on the screen at all.

Referring back to FIG. 5, when it is determined that the pointer P is not located on any arrangement icon, the display control unit 17 performs control to omit the display of the guide image F (Step S32). The determination unit 15 then determines whether the window W has been dropped within a predetermined period of time (Step S34). When it is determined that the window W has not been dropped within the predetermined period of time, the fitting processing proceeds back to Step S24 in which the information acquisition unit 14 acquires the current position of the pointer P, and repeats the steps after Step S24. When it is determined that the window W has been dropped within the predetermined period of time, the fitting processing ends. In this case, the window W is displayed at its drop position with its size unchanged,

Meanwhile, after the guide image F is displayed in Step S30, the determination unit 15 determines whether the window W has been dropped within a predetermined period of time since the guide image F has been displayed (Step S36). When it is determined that the window W has not been dropped within the predetermined period of time, the fitting processing proceeds back to Step S24 in which the information acquisition unit 14 acquires the current position of the pointer P, and repeats the steps after Step S24. When it is determined in Step S36 that the window W has been dropped within the predetermined period of time, the determination unit 15 determines whether the window W has been dropped over a different window (Step S38).

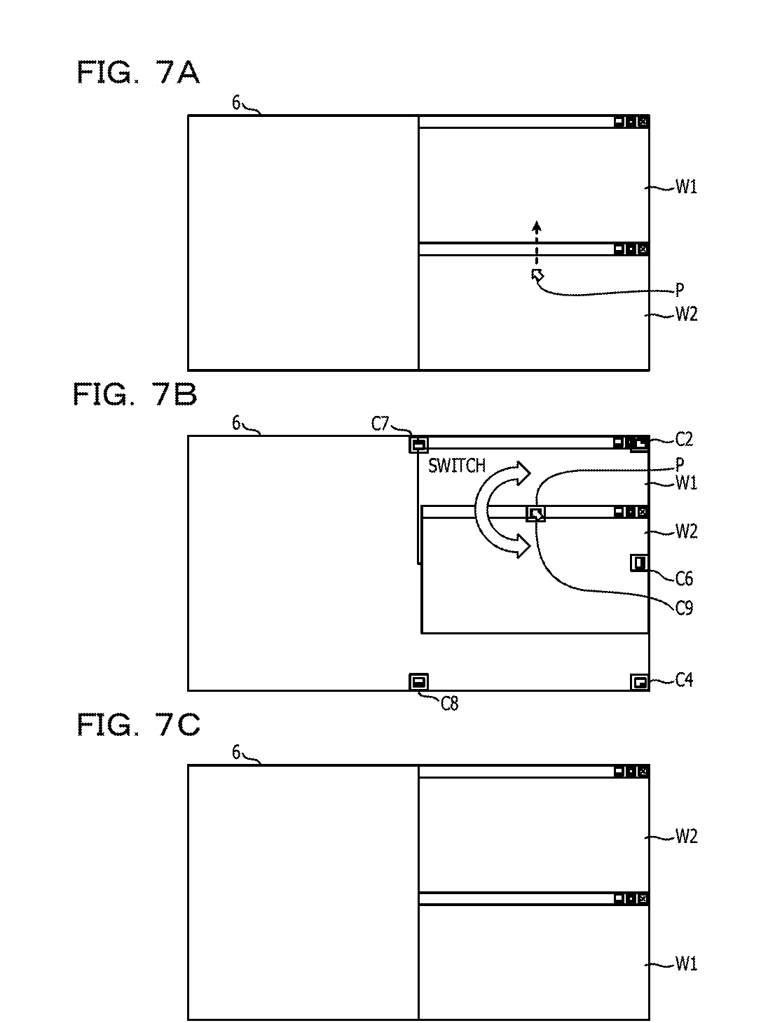

In the present embodiment, when a window W2 is dropped over the particular arrangement icon C9 on the different window W1 as illustrated in FIG. 7B, it is determined that the window W2 has been dropped over the different window W1. The embodiment is however not limited to this. It may be determined that the window W2 has been dropped over the different window W1 when the drop operation is performed with the pointer P being located at any position on the display area where the different window W1 is displayed.

Referring back to FIG. 5, when it is determined that the window has not been dropped over a different window, the display control unit 17 resizes the window according to the fitting area and displays the resized window (Step S40). The fitting processing then ends. This processing allows the dropped window W to be displayed after being automatically resized to fit the particular fitting area, as illustrated in FIG. 6C.

Finally, a description is given of processing performed in Steps S42 and S44 in FIG. 5, in which the dropped window W is displayed after being switched with a different window and resized to fit a particular fitting area On the screen in FIG. 7A, the different window W1 is already fitted and displayed in the upper right quarter fitting area. In Step S26, the display control unit 17 reads the fitting coordinate table 20 and displays the arrangement icon 21 “C9” in the center of an overlap between the dragged window W2 and the different window W1, as illustrated in FIG. 7B.

Then, the determination unit 15 determines whether the pointer P is located on the arrangement icon (Step S28). In this case, the pointer P is located on the arrangement icon 21 “C9”. Thus, the display control unit 17 displays the guide image F in Step S30. In the present embodiment, however, the guide image F is not displayed because the coordinates of fitting area 23 is not set for the arrangement icon 21 “C9” of the fitting coordinate table 20. Thus, the processing proceeds to Step S36 without displaying the guide image F corresponding to the arrangement icon 21 “C9”. When it is determined in Step S36 that the dragged window W has been dropped on a different window within the predetermined period of time, the display control unit 17 switches the display positions of the dropped window W and the different window (Step S42). Next, the display control unit 17 displays the dropped window W on the switched fitting area (Step S44). The processing then ends.

In FIG. 7B, the pointer P is moved over the arrangement icon 21 “C9”, and the window W2 is dropped at this position. This drop operation switches the display positions of the window W2 and the different window W1 such that, as illustrated in FIG. 7C, the dropped window W2 is displayed at the pre-switch display position of the different window W1 after being resized to fit the pre-switch display area of the different window W1, whereas the different window W1 is displayed at the pre-switch display position of the window W2. The pre-switch display position of the window W2 is being stored in the window position information 33 in the data management table 30. This allows the display control unit 17 to display the different window W1 at the pre-switch display position of the window W2 based on the window position information 33.

As described above, the display control method according to the present embodiment allows the user to display a window at an intended position on the display screen more easily than placing the window directly at the intended position. In particular, without limiting operational freedom in moving a window to any position on the display screen, the display control method according to the present embodiment allows a window to be automatically displayed at an intended position in an intended size more easily than when the user places the window by manually making fine adjustments thereon.

The fitting areas, which respectively correspond to the multiple locations on the display screen, are display areas that do not overlap one another. The dropped window W is displayed after being resized to fit a particular fitting area. This enables nonoverlapping arrangement of multiple windows on the screen more easily than arranging them by manually changing the position and size of each window W.

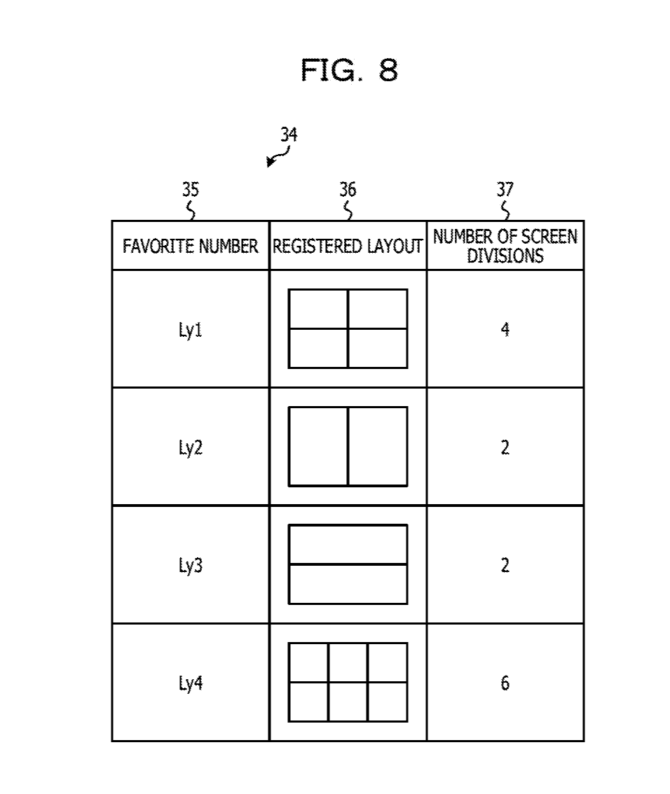

The recording unit 13 may register the favorite layout information 34 in the data management table 30. As illustrated in FIG. 8, the favorite layout information 34 may have the following data items: favorite number 35, registered layout 36, and number of screen divisions 37. Based on the registered layout 36 specified by the favorite number 35, multiple windows may be displayed after being resized and rearranged according to a specified favorite layout. For example, the multiple windows may be displayed according to a preset layout in the registered layout 36 specified by the favorite number 35.

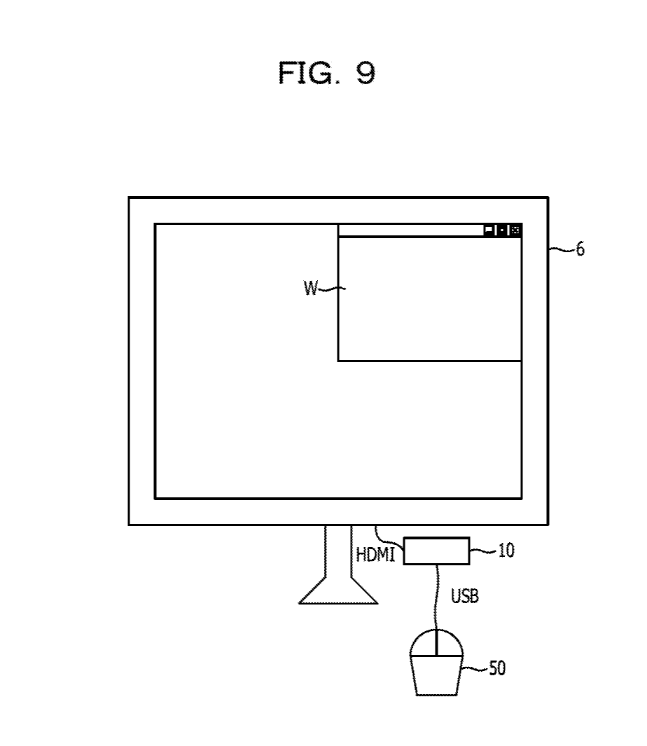

Although the display control device 1 is integral with the display device 6 in the present embodiment, the embodiment is not limited to this. For example, a display control device 10 according to the present embodiment may be configured separately from the display device 6, as illustrated in FIG. 9. Examples of the display control device 10 include a stick computer (a mouse computer).

For example, the display control device 10 is connected to the display device 6 by plugging a High-Definition Multimedia Interface (HDMI (registered trademark)) connector of the display control device 10 into an HDMI port of the display device 6. Examples of the display device 6 include a television, a display, and a projector. An input device such as a mouse 50 may be connected to a USB port of the display control device 10. The mouse 50 is used to allow the window W displayed on the display device 6 to move.

The display control device, the display control method, and the display control program have been described above through the embodiment. However, the display control device, the display control method, and the display control program according to the present disclosure are not limited to the ones described in the embodiment, and may be modified and improved variously without departing from the present disclosure. If there are more than one embodiment and modification, they may be combined as long as contradiction does not occur.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A display control method executed by a computer, the display control method comprising:
receiving a drag operation performed on a window displayed on a display screen;
displaying a plurality of arrangement icons on the display screen at preset areas on the display screen, the arrangement icons corresponding to at least one of a plurality of divided display areas, the divided display areas being at least one set of non-overlapping portions of the display screen, the at least one set of non-overlapping portions of the display screen covering the entire display screen; and
when a drop position of the drag operation is within one of the preset areas on the display screen, displaying the window at a size and location corresponding to the at least one of the plurality of divided display areas represented by an arrangement icon displayed at the one of the preset areas.

2. The display control method according to claim 1, wherein
the window is displayed after being resized to fit the size of the one of the plurality of divided display areas.

3. The display control method according to claim 1, further comprising:
displaying a guide image when the window is moved to the one of the preset areas on the display screen and while the drag operation is performed, and
wherein the guide image shows borders of the one of the plurality of divided display areas represented by the arrangement icon displayed at the one of the preset areas.

4. The display control method according to ^{claim} 1,
wherein the drop position is also within another window displayed on the display screen, and
the display control method further comprising displaying the another window at an area where the window was displayed before the drag operation.

5. The display control method according to claim 1, wherein the divided display areas include at least two different sets of non-overlapping portions of the display screen, a first set of the at least two different sets of non-overlapping portions of the display screen covering the entire display screen in a first arrangement and a second set of the at least two different sets of non-overlapping portions of the display screen covering the entire display screen in a second arrangement that is different from the first arrangement.

6. The display control method according to claim 1, wherein each arrangement icon shows an icon sized image of a highlighted one of the plurality of divided display areas.

7. A display control device comprising:
a memory; and
a processor coupled to the memory and configured to:
receive a drag operation performed on a window displayed on a display screen,
display a plurality of arrangement icons on the display screen at preset areas on the display screen, the arrangement icons corresponding to at least one of a plurality of divided display areas, the divided display areas being at least one set of non-overlapping portions of the display screen, the at least one set of non-overlapping portions of the display screen covering the entire display screen, and
when a drop position of the drag operation is within one of the preset areas on the display screen, display the window at a size and location corresponding to the at least one of the plurality of divided display areas represented by an arrangement icon displayed at the one of the preset areas.

8. The display control device according to claim 7, wherein
the window is displayed after being resized to fit the size of the one of the plurality of divided display areas.

9. The display control device according to claim 7, wherein
the processor is configured to display a guide image when the window is moved to the one of the preset areas on the display screen and while the drag operation is performed, and
the guide image shows borders of the one of the plurality of divided display areas represented by the arrangement icon displayed at the one of the preset areas.

10. The display control device according to claim 7, wherein
the drop position is also within another window displayed on the display screen, and
the processor is configured to display the another window at an area where the window was displayed before the drag operation.

11. The display control device according to claim 7, wherein the divided display areas include at least two different sets of non-overlapping portions of the display screen, a first set of the at least two different sets of non-overlapping portions of the display screen covering the entire display screen in a first arrangement and a second set of the at least two different sets of non-overlapping portions of the display screen covering the entire display screen in a second arrangement that is different from the first arrangement.

12. A display control device comprising:
an operation reception unit configured to receive a drag operation performed on a window displayed on a display screen;
a determination unit configured to determine when a drop position of the drag operation is within one of a plurality of preset areas on the display screen; and
a display control unit configured to:
display a plurality of arrangement icons on the display screen at the preset areas on the display screen, the arrangement icons corresponding to at least one of a plurality of divided display areas, the divided display areas being at least one set of non-overlapping portions of the display screen, the at least one set of non-overlapping portions of the display screen covering the entire display screen, and
when the determination unit determines that the drop position of the drag operation is within the one of the preset areas on the display screen, displaying the window at a size and location corresponding to the at least one of the plurality of divided display areas represented by an arrangement icon displayed at the one of the preset areas.

13. The display control device according to claim 12, wherein the display control unit displays the window after being resized to fit the size of the one of the plurality of divided display areas.

14. The display control device according to claim 12, wherein
the display control unit displays a guide image when the window is moved to the one of the preset areas on the display screen and while the drag operation is performed, and
the guide image shows borders of the one of the plurality of divided display areas represented by the arrangement icon displayed at the one of the preset areas.

15. The display control device according to claim 12, wherein
the drop position is also within another window displayed on the display screen, and
the display control unit displays the another window at an area where the window was displayed before the drag operation.

16. The display control device according to claim 12, wherein the divided display areas include at least two different sets of non-overlapping portions of the display screen, a first set of the at least two different sets of non-overlapping portions of the display screen covering the entire display screen in a first arrangement and a second set of the at least two different sets of non-overlapping portions of the display screen covering the entire display screen in a second arrangement that is different from the first arrangement.

17. A non-transitory computer readable medium storing a computer-executable program causing a computer to perform a process, the process comprising:
receiving a drag operation performed on a window displayed on a display screen;
displaying a plurality of arrangement icons on the display screen at preset areas on the display screen, the arrangement icons corresponding to at least one of a plurality of divided display areas, the divided display areas being at least one set of non-overlapping portions of the display screen, the at least one set of non-overlapping portions of the display screen covering the entire display screen; and
when a drop position of the drag operation is within one of the preset areas on the display screen, displaying the window at a size and location corresponding to the at least one of the plurality of divided display areas represented by an arrangement icon displayed at the one of the preset areas.

18. The non-transitory computer readable medium according to claim 17, wherein the window is displayed after being resized to fit the size of the one of the plurality of divided display areas.

19. The non-transitory computer readable medium according to claim 17, the process further comprising:
displaying a guide image when the window is moved to the one of the preset areas on the display screen and while the drag operation is performed, and
wherein the guide image shows borders of the one of the plurality of divided display areas represented by the arrangement icon displayed at the one of the preset areas.

20. The non-transitory computer readable medium according to claim 17, wherein
the drop position is also within another window displayed on the display screen, and
the process further comprising displaying the another window at an area where the window was displayed before the drag operation.
